(19) United States
(12) Patent Application Publication
(10) Pub. No.: US 2011/0133046 A1
(43) Pub. Date: Jun. 9, 2011

(54) WHEEL SENSOR MOUNTING DEVICE

(75) Inventors: JOHN EDWARD LEMERISE, MACOMB, MI (US); PETE CHRIST KOROVESIS, LIVONIA, MI (US)

(73) Assignee: FORD GLOBAL TECHNOLOGIES, LLC, DEARBORN, MI (US)

(21) Appl. No.: 12/630,841

(22) Filed: Dec. 3, 2009

(51) Int. Cl. B60T 17/22

(52) U.S. Cl. 248/230.8

(57) ABSTRACT

A device for mounting a sensor assembly on a vehicle assembly. The device includes a substantially circular ring circumferentially engaging the vehicle axle tube and a support block. The support block includes a clamp-engaging segment engaging at least a portion of the circumference of the ring. Further, the support block includes a sensor-engaging segment adapted for engaging the sensor assembly and an axle-engaging segment engaging at least a portion of the axle to position the sensor assembly with relation to the axle.

### BACKGROUND OF THE INVENTION

The present application relates generally to vehicle sensors, and more particularly, to apparatus for carrying a sensor in operable position on a vehicle.

Anti-lock braking systems (ABS) have become common safety equipment on every type of vehicle ranging from cars to trailers. A typical ABS includes a central electronic control unit (ECU), two or more hydraulic valves within the brake system, and wheel speed sensors—one for each wheel. The wheel speed sensors provide information to the ECU, which constantly monitors the wheel speed, and upon detecting a wheel rotating significantly slower than the others—a condition indicative of impending wheel lock—it actuates the valves to reduce hydraulic pressure to the brake at the affected wheel, thus reducing the braking force on that wheel.

The wheel sensors are typically located on the axle adjacent to the inboard-facing side of a wheel hub, the wheel hub incorporating a tone ring. The tone ring includes a series of teeth, which project from a surface of the tone ring. The wheel sensors detect movement of the tone ring teeth, and send corresponding signals to the ECU, enabling braking control. The position and location of the sensors with respect to the tone ring is crucial to the operation of the ABS, as any incorrect movement detection sends fallacious signals to the ECU, which in turn wrongly actuates the braking valves, causing undesired results.

Sensors are typically mounted on a backing plate near a tone ring, or a similar device. In a three channel (wheel) ABS system, wheel speed is detected through a single sensor placed on an axle near the tone ring in a ring and pinion assembly. In certain applications, space available for mounting the speed sensor becomes a constraint. While designing a four-channel (wheel) ABS system, for example, in Dual Rear Wheel (DRW) vehicles, very limited axle space is available between the wheels, and in these applications, typical mounting techniques cannot be used. Further, in modern day motor vehicle design, efficiency of packaging, lightweight, and ease of assembly are of paramount importance. Although prior art sensors mounts have been implemented, designers of such systems are constantly striving to increase their reliability, reduce packaging space requirements, and facilitate production, assembly, and calibration, all the while seeking to reduce their cost.

As a result, there exists a need for an improved sensor mounting system configured to reduce the effects of variations in the air gap between the rotor and stator, which is easier and less expensive to produce, and meets minimum packaging space requirements.

### BRIEF DESCRIPTION OF THE INVENTION

One embodiment of the present application describes a device for mounting a sensor assembly on a vehicle axle. The device comprises a substantially circular ring that circumferentially engages the vehicle axle tube. Further, the device includes a support block including a clamp-engaging segment that engages at least a portion of the ring circumference, a sensor-engaging segment that is adapted to engage the sensor assembly, and an axle-engaging segment adapted for engaging at least a portion of the axle to position the sensor assembly with relation to the axle.

Embodiments of the present disclosure provide many advantages. For example, the sensor-mounting device is very compact and can be easily fit into vehicles with space constraints near the tone ring, such as dual rear wheel vehicles. Further, due to the symmetrical structure of the sensor-mounting device, it can be fit adjacent any vehicle wheel without any modifications. Moreover, the device is inexpensive and can be formed of any suitable material with departing from the scope of the present disclosure.

These and other advantages, features, and objects of the present application will become apparent upon review of the following detailed description of the preferred embodiments when taken in conjunction with the drawings and the appended claims.

### BRIEF DESCRIPTION OF THE DRAWINGS

FIG. 1 is a schematic exploded view of an exemplary sensor-mounting device.

FIG. 2 is a side-view of the sensor-mounting device of FIG. 1 mounted on a vehicle axle tube.

FIG. 3 is a schematic isometric view of the sensor-mounting device of FIG. 1 mounted on a vehicle axle tube.

FIG. 4 is a schematic isometric view of an exemplary spring-type clamping ring.

FIG. 5 is a schematic isometric view of an exemplary wire-type clamping ring.

FIG. 6 is a schematic isometric view of an exemplary screw-type clamping ring.

FIG. 7 is a schematic isometric view of an exemplary over-center-type clamping ring.

FIGS. 8-11 illustrate multiple exemplary support block forms.

FIGS. 12-15 illustrate multiple exemplary axle aperture forms.

### DETAILED DESCRIPTION OF THE INVENTION

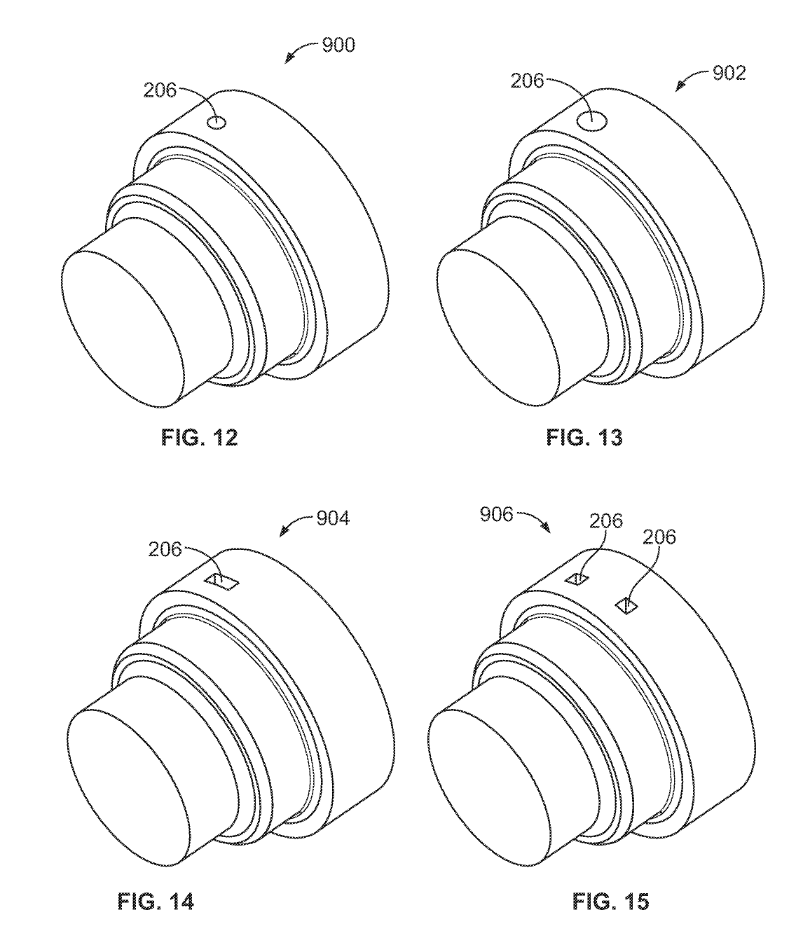

The drawings, FIGS. 1-15, wherein like characters represent the same or corresponding parts throughout the several views, depict exemplary sensor mounting devices according some embodiments of the present disclosure. The sensor-mounting device can be used in various types of vehicles including small or large cars, coupes, sedans, convertibles, trucks, vans, SUVs, dual rear wheel vehicles, and trailers. More particularly, the sensor-mounting device may be used in vehicles with mounting space constraints. In some embodiments, the sensor-mounting device is positioned on the rear or front vehicle axle adjacent to any or all wheel tone rings or any similar devices.

FIG. 1 illustrates an exploded view of an exemplary sensor-mounting device 100 according to some embodiments of the present disclosure. The sensor-mounting device 100 includes a substantially circular ring 102 and a support block 104. The ring 102, further, may be a clamping device, the diameter of which can be varied depending on the axle width, position of the sensor, and so on.

The support block 104 includes a clamp-engaging portion 106, a sensor-engaging portion 108, and an axle-engaging portion 110. The clamp-engaging portion 106 may be the bottom surface of the support block 104 and may be molded over the ring 102. Alternatively, the clamp-engaging portion 106 may be a snap-fit assembly. In the latter scenario, the clamp-engaging portion 106 includes two parallel surfaces, substantially arcuate, separated by a distance comparable to the ring's thickness. These two parallel surfaces engage the ring 102, one surface engaging the outer surface of ring 102, and the other surface engaging the ring's inner surface, thereby snapping onto the ring circumference.

The sensor-engaging portion 108 may include one or more recesses, protrusions, bolts, nuts, locks, or latches. These features engage corresponding features that may be present on the sensor. For example, if the sensor includes one protrusion and one recess, the sensor-engaging portion 108 may include one recess and one protrusion engaging with the protrusion and recess of the sensor assembly respectively. Other engaging features include slide-fits, rabbet fits, and so on. It will be appreciated by a person skilled in the art that the sensor-engaging portion 108 may include one or more fits, depending on the sensor assembly, without departing from the scope of the present disclosure.

The structure of the axle-engaging portion 110 may again vary depending on the application. In one embodiment of the present disclosure, the axle-engaging portion 110 may be a locator pin, of any shape, that can engage a corresponding locator aperture present on the axle tube. Alternatively, the axle-engaging portion 110 may be a locator aperture that may engage a corresponding locator pin present on the axle tube. It will be understood that the axle-engaging portion 110 secures the sensor position with relation to the axle tube and the tone ring. Any means for fixing this position can be contemplated and those means will not fall outside the scope of the present disclosure. For example, the axle-engaging portion 110 may include latches, nuts, bolts, apertures, pins, blocks, rabbet fits, slide fits, and so on.

In one embodiment of the present disclosure, the support block 104 is symmetrical about a central axis. Symmetry allows the same sensor-mounting device 100 to be fitted in any orientation on any wheel of the vehicle without modifications or alterations.

The sensor-mounting device 100 as described with reference to FIG. 1 is a compact and inexpensive device that can be positioned on vehicle axles with space limitations as the device requires little space for installation. Moreover, no changes are required in existing vehicle axles or tone rings (other than a locator aperture in the axle tube for positing the sensor with respect to the tone ring) to incorporate the sensor-mounting device 100. For example, in dual rear wheel (DRW) vehicles—a known case of limited axle space—the sensor-mounting device 100 of the present disclosure may be implemented successfully on each wheel without any alteration in the present axle or wheel design. Further, the placement of the sensor mounting device 100 adjacent the tone ring ensure that the air gap between the sensor and the tone ring is minimum and that the air gap remains uniform during vibrations, providing accurate wheel speed monitoring.

FIG. 2 is a side view 200 of the sensor mounting device 100 mounted on a vehicle axle tube 202. The ring 102 is slipped onto the axle tube 202, until it reaches the axle tube 202 end adjacent to a tone ring 204. In one implementation, the ring 102 is approximately the same diameter as the axle tube 202 end closest to the tone ring 204.

The axle tube 204 further includes a locator aperture 206. The corresponding axle-engaging portion 110, such as a locator, engages this locator aperture 206 to position a vehicle speed sensor, such as sensor 208 accurately with respect to the tone ring 204. The accurate placement of the sensor 208 is required for correctly sensing the tone ring 204 speed. Any movement in the sensor 208 with respect to the tone ring 204 can result in erroneous data. Therefore, the axle-engaging portion 110 and the locator aperture 206 provide position locking, such that the sensor-mounting device 100 can withstand motional vibrations and tolerances without affecting the sensor 208 position.

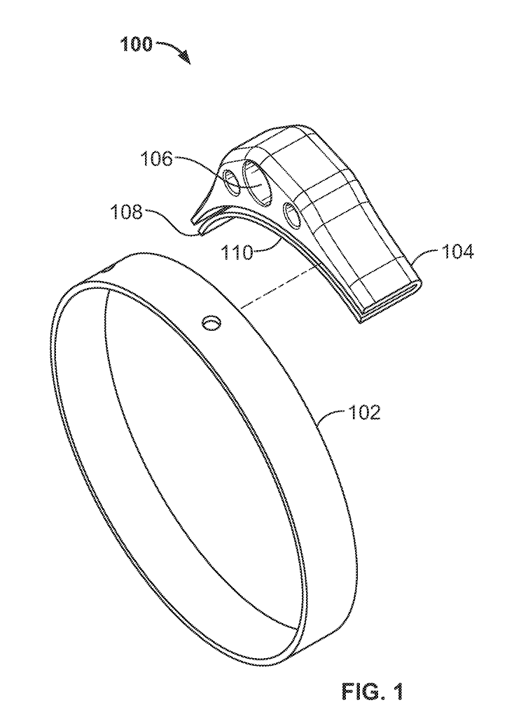

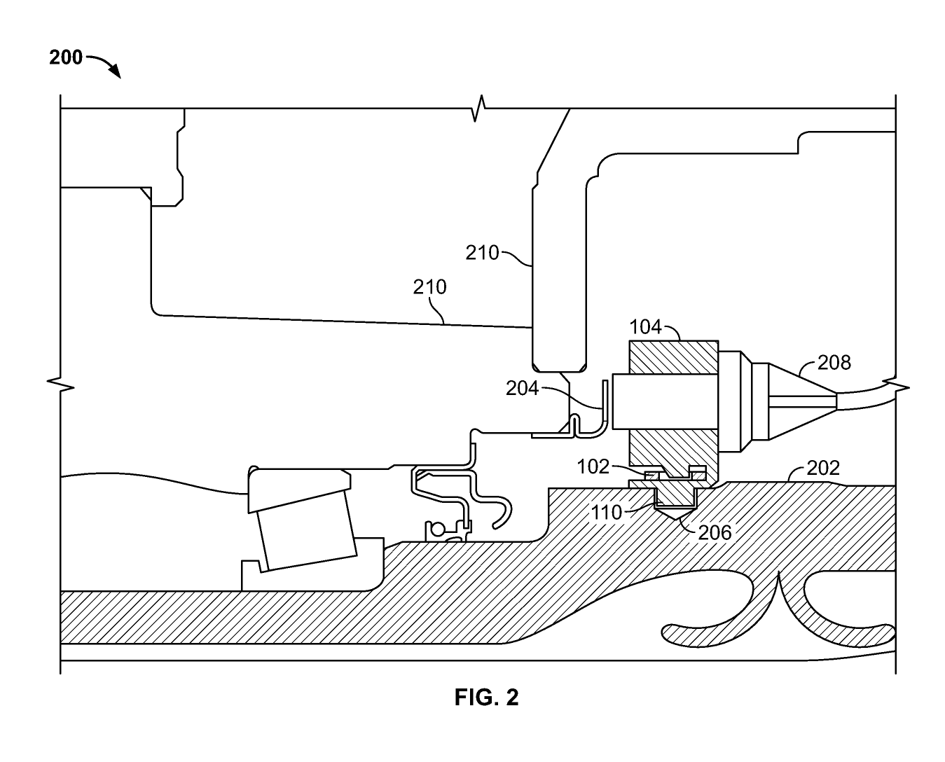

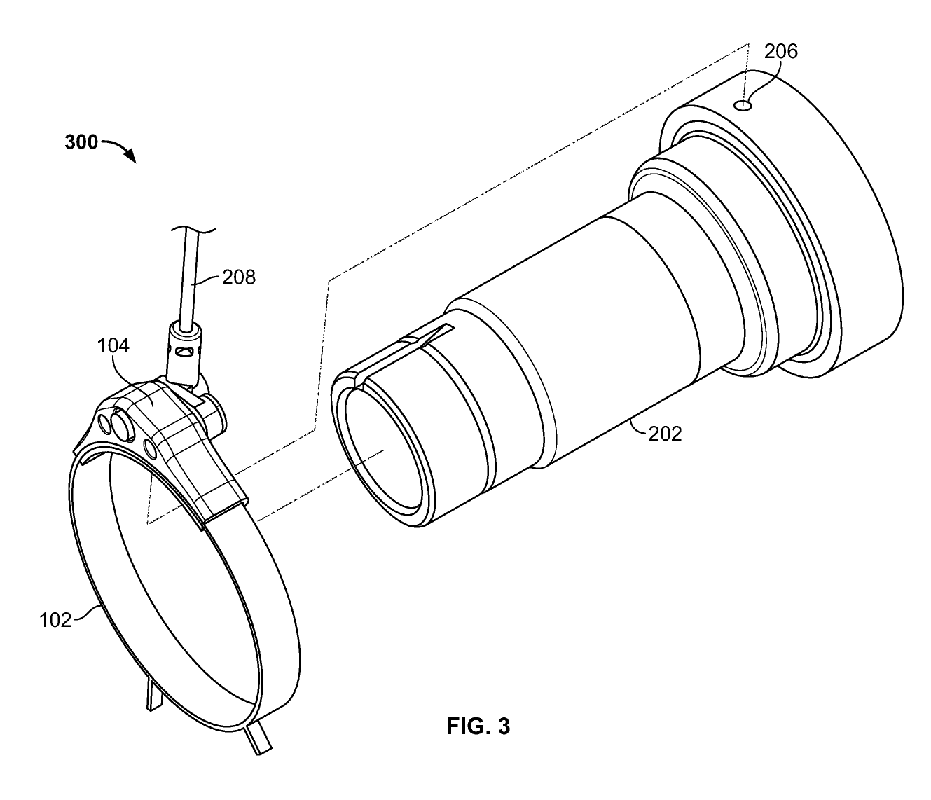

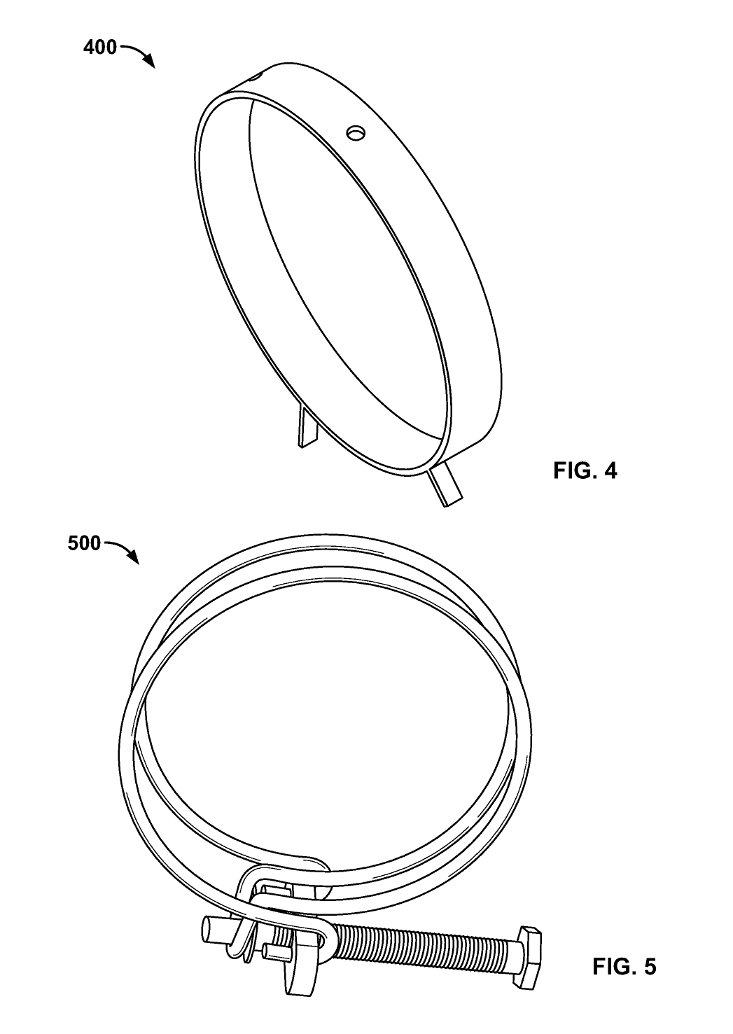

Once the sensor-mounting device 100 is placed near the tone ring 204, and the axle-engaging portion 110 is properly engaged with the locator aperture 206, the ring 102 may be welded or bolted onto the axle tube 202. In another implementation, the ring 102 may be a tension clamp, and is slipped onto the axle tube 202 in its open position. When the sensor-mounting device 100 is properly positioned, the tension clamp is released or closed, such that the tension clamp clutches the axle tube 202 asserting constant tension on the axle tube 202. Different types of tension clamps may be used and FIGS. 4-7 depict some of these.

The tone ring 204 is mechanically coupled to the hub and drive assembly 210 of the vehicle. This is a standard hub-and-drive assembly, and will not be described in detail here.

FIG. 3 illustrates an isometric view 300 of the sensor-mounting device 100 and the axle tube 202. The sensor-mounting device 100 is slipped onto the axle tube 202, and clamped or molded over the end of the axle tube 202 closest to the tone ring 204. The axle-engaging portion 110 engages with the aperture 206 to fix the position of the sensor 208 with respect to the tone ring 204.

FIG. 4 is an isometric view of a spring-type tension clamp 400. The clamp 400 includes two arcuate segments that overlap circumferentially and a tension means, which decreases the overlap distance between the two segments, upon application of a force. Once the clamp 400 is positioned on the axle tube 202, the force is removed, the overlap distance between the clamp sections increases, tightening the clamp 400 on the axle tube 202. The clamp 400 then exerts constant tension on the axle tube 202, fixing the support block 104 and the engaged sensor 208 onto the axle tube 202.

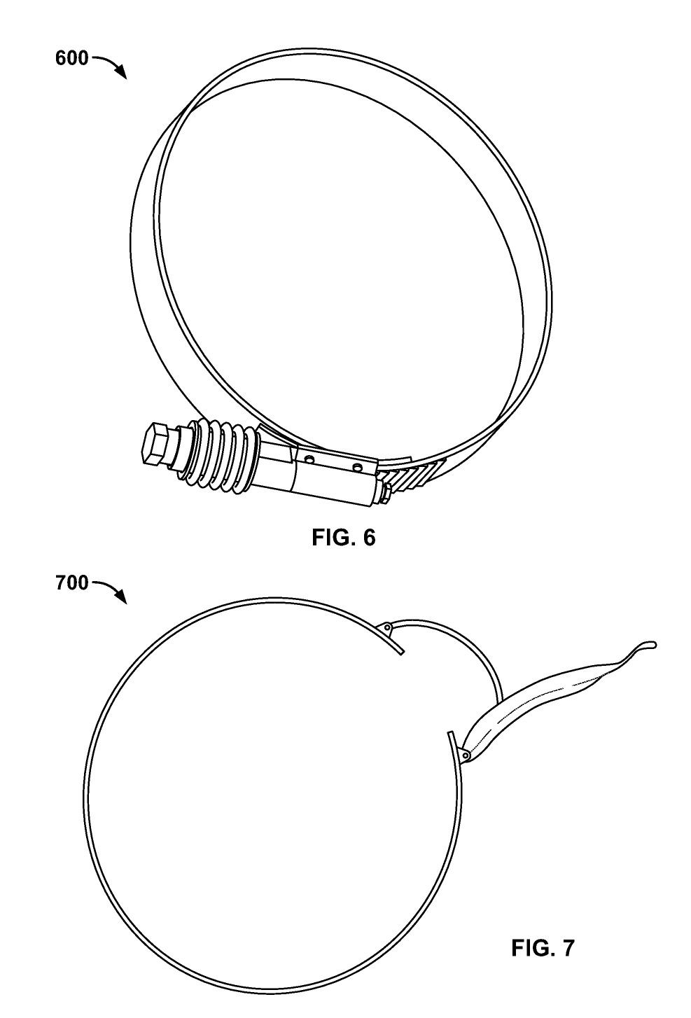

FIG. 5 is an isometric view of a wire clamp 500. The clamp 500 includes one or more substantially circular wires adapted to clamp the axle tube 202. The diameter of the wire and in turn the tension provided by the clamp 500 can be varied using a screw assembly or a spring assembly. FIG. 6 illustrates a screw type clamp 600, which can be fixed onto the axle tube 202 using a screw assembly 602. FIG. 7 illustrates an over-centre clamp 700. The clamp 700 is slipped onto the axle tube 202 in the open position; and once positioned, the clamp 700 can be “closed,” providing constant tension. It will be understood that the clamps depicted in FIGS. 4-7 are widely known in the art, and therefore they are not described in detail here. Further, it will be appreciated that other types of clamps may be interchangeably used here if they provide the same functionality as the ring 102.

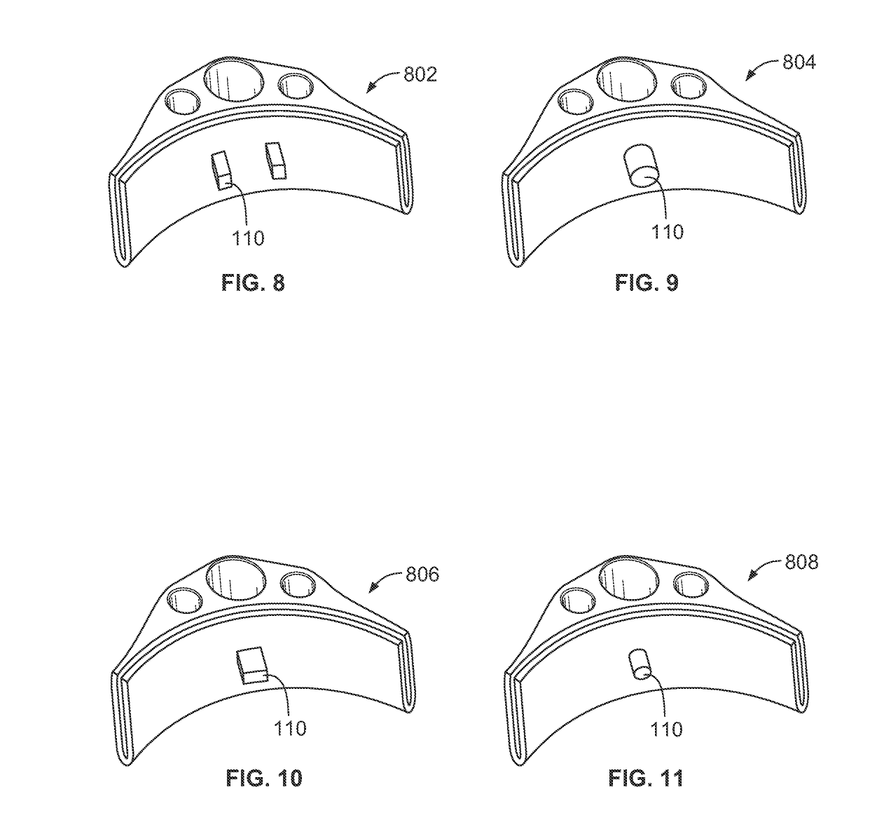

FIGS. 8-11 depict exemplary axle-engaging portions 110 of the support block 104. In one embodiment of the present disclosure, the axle-engaging portion 110 includes one or more cylindrical locator pins located on the bottom surface of the support block 104. The locator pins may be symmetrically located; alternatively, the locator pins can be located in a random manner. In another embodiment, the axle-engaging portion 110 may be ovular, or elliptical. In yet another embodiment, the locator pins may be one or more rectangular blocks extending from the substantially arcuate bottom surface of the support block 104. These embodiments are illustrated here merely as examples and it will be understood that various other forms and shapes may be discerned for the axle-engaging portion 110. Further, the figure only illustrates locator pins, it will be readily understood that instead of pins, the axle-engaging portion 110 may include similarly designed apertures.

FIGS. 12-15 illustrate exemplary locator aperture 206 embodiments. In one embodiment of the present disclosure, the locator aperture 206 includes one or more circular apertures sized according to the corresponding locator pins. In another embodiment, the locator aperture 206 may be elliptical or oval; alternatively, the locator apertures may include one or more rectangular apertures corresponding to the rectangular locator pins of FIGS. 8-11. Depending on the type of axle-engaging portion 110, the locator aperture 206 can be adapted to engage the axle-engaging portion 110. Further, it will be understood that the figure merely represents locator apertures and that these may easily be replaced by pins, latches, or bolts of similar configuration without departing from the scope of the present disclosure.

The embodiments of the present disclosure described herein provide a sensor-mounting device 100 capable of positioning a wheel speed sensor accurately adjacent to a vehicle tone ring, in limited space applications. The sensor-mounting device 100 is low cost, light, easy to manufacture and maintain, and simple to construct. Furthermore, the sensor-mounting device 100 is robust to tolerance stack-ups and can be assembled with minimum or no change to the existing vehicle axle and wheel structure.

While the best mode for carrying out the invention has been described in detail, those familiar with the art to which this invention relates will recognize various alternative designs and embodiments for practicing the invention as described by the claims.

1. A device for mounting a sensor assembly on a vehicle axle, the device comprising:
a substantially circular ring for circumferentially engaging the vehicle axle; and
a support block, including:
a clamp-engaging segment for engaging at least a portion of the circumference of the ring;
a sensor-engaging segment adapted for engaging the sensor assembly; and
an axle-engaging segment adapted for engaging at least a portion of the axle to position the sensor assembly with relation to the axle.

2. The device of claim 1, wherein the ring is a tension clamp.

3. The device of claim 2, wherein the tension clamp includes at least one of a spring type clamp, a screw-type clamp, an over centre clamp, or a wire clamp.

4. The device of claim 1, wherein the clamp-engaging segment includes a substantially arcuate surface.

5. The device of claim 1, wherein the clamp-engaging segment is molded over at least a portion of the circumference of the ring.

6. The device of claim 1, wherein the clamp-engaging segment is a snap-fit assembly.

7. The device of claim 5, wherein the snap-fit assembly includes two parallel surfaces, substantially arcuate, separated by a distance comparable to the width of the clamping ring, and wherein the two parallel surfaces engage with at least a portion of the ring's circumference, snapping-on to the ring.

8. The device of claim 1, wherein the sensor-engaging segment includes one or more of protrusions, apertures, latches, bolts, nuts, or locks.

9. The device of claim 1, wherein the support block is substantially symmetrical about a central axis.

10. The device of claim 1, wherein the axle-engaging segment includes at least one locator.

11. The device of claim 10, wherein the locator extends downwardly from the bottom surface of the support block.

12. The device of claim 10, wherein the locator engages with a corresponding aperture in the axle tube assembly to radially and axially position the sensor assembly with relation to the axle tube assembly.

13. The device of claim 10, wherein the locator is one of a pin, a block, a latch, or a screw.

14. A device for mounting a sensor assembly on a vehicle axle, the device comprising:
a substantially circular clamping ring for circumferentially engaging an axle tube assembly adjacent to a wheel hub tone ring; and
a support block including:
a bottom surface, substantially arcuate, engaging at least a portion of the circumference of the clamping ring;
a sensor-engaging segment adapted for engaging with at least a portion of the sensor assembly; and
one or more locator pins extending downwardly from the bottom surface;
wherein the one or more locator pins engage one or more locator apertures on the axle tube assembly to axially and radially position the sensor assembly with relation to the axle tube assembly.

15. The device of claim 14, wherein the support block includes a snap fit assembly to snap the support block onto at least a portion of the clamping ring.

16. The device of claim 14, wherein the bottom surface of the support block is molded onto at least a portion of the clamping ring.

17. The device of claim 14, wherein the locator pin includes round pins, oval pins, block pins, or latches.

18. The device of claim 14, wherein the locator aperture includes round apertures, oval apertures, or block apertures.

19. The device of claim 14 is used in dual rear wheel vehicles.
